(19) United States
(12) Patent Application Publication
(10) Pub. No.: US 2023/0304245 A1
(43) Pub. Date: Sep. 28, 2023

(54) WAVE ATTENUATION METHOD AND DEVICE

(71) Applicant: BLUERIUM, AIX-EN-PROVENCE (FR)

(72) Inventor: Emmanuel ROBERT, TRETS (FR)

(73) Assignee: BLUERIUM, AIX-EN-PROVENCE (FR)

(21) Appl. No.: 18/040,934

(22) PCT Filed: Aug. 9, 2021
(86) PCT No.: PCT/FR2021/051457

§ 371 Date: Feb. 7, 2023

(30) Foreign Application Priority Data
Aug. 7, 2020 (FR) FR2008367

(51) Int. Cl. E02B 3/06

(52) U.S. Cl. CPC E02B 3/062

(57) ABSTRACT

A method of attenuating the amplitude of waves having a given center wavelength, the method including the use of a device including: an assembly of a plurality of modules juxtaposed next to each other along a given direction, each module including at least one cavity having a first opening and a second opening; wherein the modules are placed in a position in which the first opening of each cavity is permanently submerged and the second opening is in communication with the ambient air, the dimensions of the cavities being determined so that each cavity forms a resonant cavity at the given center frequency.

### FIELD

This paper is concerned with wave attenuation devices and processes.

### BACKGROUND

A wave visible on the surface of the water represents the visible part of an undulatory phenomenon of which another part is located under the surface of the water. Indeed, a wave propagates on the surface of the water but also on a certain depth which depends on the wavelength of the wave. As an example, considering a water depth of 6 m, a wave 10 with a wavelength of 17 m will cause a fluid movement over a depth of about 3 m that we can call penetration height. Beyond this depth, the water movement becomes negligible. To stop totally or partially the propagation of this wave, it is known to place a wall 12 partially immersed on a height of 3 m (FIG. 1). This wall will then be able to stop any wave whose penetration height is lower than 3 m, i.e. with wavelengths lower than 17 m.

However, considering a wave 14 with a wavelength of 34 m with a penetration height of about 6 m, the wall 12 as shown in FIG. 1 will not be high enough and part of the wave 14 will pass under it, making the wall 12 ineffective (FIG. 2).

However, the period of the waves at sea generally varies between 3 and 8 seconds. In a harbour area with a water depth of 6 m, this generates waves with a wavelength of 14 m to 60 m.

FIG. 3 represents the variation of the transmission rate (ratio of the transmitted wave amplitude to the incident wave amplitude) as a function of the wave wavelength. It is further observed that the wave that a 3 m wall 12 as mentioned above is only effective at at least 50% transmission for wavelengths less than 30 m, which is not satisfactory in the context of a fixed installation, expensive and complicated to install.

Furthermore, we know the document US2016273512A1 comprising a cavity with two openings, one of which is in communication with a liquid flow and the other is in communication with the air. This type of device allows to reduce the amplitude of the waves at the crossing of the device but is very cumbersome.

### SUMMARY

Thus, the present document provides a method of attenuating the amplitude of waves transmitted through a device having a given center frequency, the method comprising using the device comprising:
a set of a plurality of modules juxtaposed next to each other along a given direction, each module comprising at least one cavity, for example tubular, having a first opening and a second opening;
wherein the modules are placed in a position in which the first opening of each cavity is permanently immersed and in which the second opening is in communication with the ambient air, the dimensions of the cavities and openings being determined so that at least one cavity of each module forms a resonant cavity at the given center frequency.

In one embodiment, each cavity forms a resonant cavity at the given center frequency.

The method according to the invention consists of fixing the frequency that one wishes to absorb with a cavity, then determining the dimensional parameters of the first aperture in combination with the width of the cavity to obtain the desired resonant frequency for said cavity.

The process according to the present document makes it possible to attenuate the waves, i.e. to limit the transmission of the amplitude of the incident waves from one side to the other of the modules. The implementation of the process at the level of a coastline makes it possible to protect it from the waves.

The cavity or cavities used in the invention are so-called resonant cavities, which implies that they have the ability to achieve resonance, which is not the case with devices or installations of the prior art. For example, in US2016273512A1, the cavity is not a resonant cavity.

The present document also relates to an assembly comprising one or more modules, each module comprising N resonant cavities, having a first aperture and a second aperture, with at least k cavities having different widths in pairs, k being less than or equal to N. The width of each of the k cavities is thus adapted to resonate at a different center frequency than the other k cavities, so that when a wave impacts a module, some of the k cavities among the N cavities will be able to attenuate the amplitude of the waves at a first resonant frequency and others of the k cavities among the N cavities will be able to attenuate the amplitude of the waves at a second resonant frequency different from the first resonant frequency. By using k cavities as defined above, it is thus possible to achieve an attenuation of the wave amplitude over a wide frequency range.

As previously described, the first opening is intended to be submerged and the second opening is intended to be in communication with the ambient air.

The width corresponds to the direction of propagation of the waves and the length corresponds to a direction perpendicular to the direction of propagation of the waves, the width and length being perpendicular to the vertical in use.

Furthermore, each module may comprise at least two first cavities with a first width and arranged side by side and two other cavities whose sum of the widths is equal to the first width. Of the other two cavities, a second cavity may have a second width and a third cavity may have a third width, the latter of which may be greater than the second width. The second cavity and the third cavity may be arranged one behind the other along the wave propagation direction. The first two cavities, the second cavity and the third cavity may have the same length.

The device thus formed comprises modules juxtaposed next to each other, each module comprising an upstream wall and a downstream wall with respect to the natural direction of propagation of the waves and two side walls, the side walls of the modules facing each other, the upstream and downstream walls of each module being free of contact with another module, the upstream wall facing the waves and the downstream face facing the part to be protected from the waves. Each resonant cavity also includes a bottom wall facing the water bottom.

The dimensions of the cavities are determined so that each cavity forms a resonant cavity at the given center frequency. In practice, each cavity dimension is at least ten times smaller than the central wavelength of the waves.

According to the proposed method, the discretization of the resonant cavities allows the wavefront to be nearly identical across the width of each resonant cavity. Thus, the lateral dimension of each cavity is chosen to be able to assume that the amplitude of the wavefront of an impacting wave is the same across the entire width of a resonant cavity, i.e. across the entire lateral dimension of a cavity.

The use of resonant cavities works on the principle of an oscillation of the liquid mass contained in the cavity, in phase opposition with the wave incident on the upstream walls of the modules, thus allowing to reduce the transmission of waves from one side to the other of the resonant cavities.

A set formed by the modules can thus form a substantially straight line.

A resonant cavity may have the shape of a tube with a cross-section of, for example, a square or rectangular or any other suitable shape and which comprises a first submerged opening arranged on one of an upstream face, a downstream face and a bottom face and a second opening which is formed at one end of the tubular shape, this end being the one which opens to the ambient air.

The attenuation process according to the present document proves to be simpler to install than a wall of the previous technique, because of the low mass of the modules to be moved in comparison with the structural elements necessary to carry out a wall.

Each module may include at least two, for example three, resonant cavities arranged side by side. Each module could have a smaller or larger number. The number of three resonant cavities is interesting because the dimensions of the cavities are the best compromise for handling the modules.

The first opening of each cavity can have a cross-section between 0.5 and 5 m².

This section of the first opening makes it possible to stop waves with a period of between 3 and 8 s, this period corresponding to that generally observed on a coastline and being equivalent to a wave length of between 15 and 55 m.

We note that the shape of the section has little impact on the central frequency stopped by the resonant cavities, it is the area that essentially defines the resonant frequency, in addition to the dimensions of the resonant cavity.

The first opening can have any shape, which can be a rectangle that can be horizontal or vertical, a square, a round, or a portion of a disk with an angular opening that can for example have an angular opening of 90°.

The first opening can be placed on the upstream wall and thus opposite the waves, on the downstream wall or on a bottom wall, i.e. opposite the water bottom.

The height of water separating a bottom from each cavity should be less than half the height of water separating the bottom.

This arrangement allows for a good compromise between module size and wave attenuation.

The term “water height” is used here to mean the water height measured in the absence of waves.

The device may include a movable element that allows the cross-section of the first opening to be varied. In this way, the resonant frequency of the resonant cavity can be adjusted.

The device may include means for measuring the center frequency of the waves, which means are connected to means for controlling means for moving the moving element.

This configuration allows a real time adaptation of the resonance frequency of the resonant cavities in order to block the transmission of the wave amplitude.

Each module may include means for varying the height position of the second opening of each cavity.

Each module may include a first portion having the first opening and a second portion having the second opening and sealingly movable relative to the first portion so as to vary the height position of the second opening.

The second portion may be configured to slide sealingly relative to the first portion and includes float means.

Each module may include a movable panel sealed to an upstream wall of the module, said panel including float means.

The modules can be structurally separate from each other and can be connected to each other by an isostatic connection. In this case, the modules can be laid on the bottom of the water. Each module may be connected at a first lateral end to the water bottom by a point connection and at its second lateral end by a linear-annular connection to the first end of an adjacent module. If these connections are based on levelled embankments, then this type of connection allows for variations in the level of the water bottom on which the modules are intended to be placed.

When the modules are floating they can be connected to the bottom by chains that can form a lattice. The length of the chains is adjusted to allow the modules to be level and aligned.

According to another feature, the device may comprise at least two assemblies of the aforementioned type, connected to each other so as to have a V shape.

The device may further comprise a plurality of assemblies of the aforementioned type so as to present a succession of V-shapes. The V-shape may have an angular opening of between 30° and 120°.

The device may include four assemblies assembled in a diamond shape, providing multi-directional protection.

In yet another embodiment, the device may comprise a plurality of assemblies connected to each other to form a closed contour structure for example to protect device objects placed within said contour.

The modules can be placed on the bottom of the water or have positive buoyancy and are retained on the bottom.

In the various aforementioned variants or examples of the invention, each cavity may have a width, i.e., a dimension along the direction of wave propagation, that is about 10 times smaller than the central wavelength of the wave whose amplitude is to be attenuated.

In other words, on average, the width of the cavity is one tenth of the wavelength incident on said cavity. When the module includes several cavities which can attenuate different central wave lengths, it will be necessary to dimension the cavities according to the above-mentioned criterion and according to the dimensional parameters of the openings with regard to the wavelengths to be attenuated.

According to another feature, each cavity can have the shape of a cylinder, for example the shape of a straight cylinder.

According to another feature, the cylinder may be open at one end along a generatrix so as to form the second opening.

In this last configuration, the resonance frequency of a cavity is thus a function of the width of the cavity, i.e. its dimension according to the direction of the waves on the said cavity and the dimensional parameters of the first opening.

Each module can have a constant width, which facilitates the installation, the manufacturing of a module and also its transport since the width is fixed.

### BRIEF DESCRIPTION OF THE FIGURES

FIG. 1 schematically illustrates the principle of wave attenuation according to the prior art and comprises a part A and a part B, A corresponding to waves having a first (smaller) wavelength, B corresponding to waves having a second (larger) wavelength;

FIG. 2 is a plot of the transmission rate of the incident wave amplitude as a function of the wave wavelength;

FIG. 3 shows a module with several resonators arranged side by side with openings towards the bottom;

FIG. 4 is a schematic illustration of several variants of a resonator usable with the invention;

FIG. 5 comprises a part A and a part B , A illustrating the principle of attenuation according to the invention and B is a graph of the wave transmission rate in percentage according to the wave length for a fixed geometry and presented in A;

FIG. 6 comprises three parts A, B and C, A representing a variant of a resonator whose immersed aperture has a variable section, B being a graph representing the variation of the transmission rate as a function of the wavelength for several sections and C being a graph representing the variation of the wavelength at zero transmission as a function of the height of the section of the immersed aperture;

FIG. 7 comprises two parts A and B, A representing another variant of a resonator whose immersed aperture has a variable section, B being a graph representing the variation of the wavelength at zero transmission as a function of the angle of the section of the immersed aperture;

FIG. 8 shows a device according to the invention comprising a second opening that can be positioned at a variable height depending on the waves;

FIG. 9 comprises two parts A and B, A being a cross-sectional view of the device according to the present disclosure and according to a sectional plane passing through several modules, B being a cross-sectional view according to the sectional plane AA of A;

FIG. 10 comprises two parts A and B, and representing two variants for connecting the modules to the sea floor;

FIGS. 11A and 11B represent two alternative embodiments of a module according to the invention;

FIG. 12 shows an example of an assembly comprising a plurality of modules as shown in FIG. 11A;

FIG. 13 represents a variant of integration of an assembly according to the invention on a coastline;

FIG. 14 represents another variant of integration of an assembly according to the invention on a coastline;

FIG. 15 is a variant of a module according to the invention;

FIG. 16 is another variant of a module according to the invention.

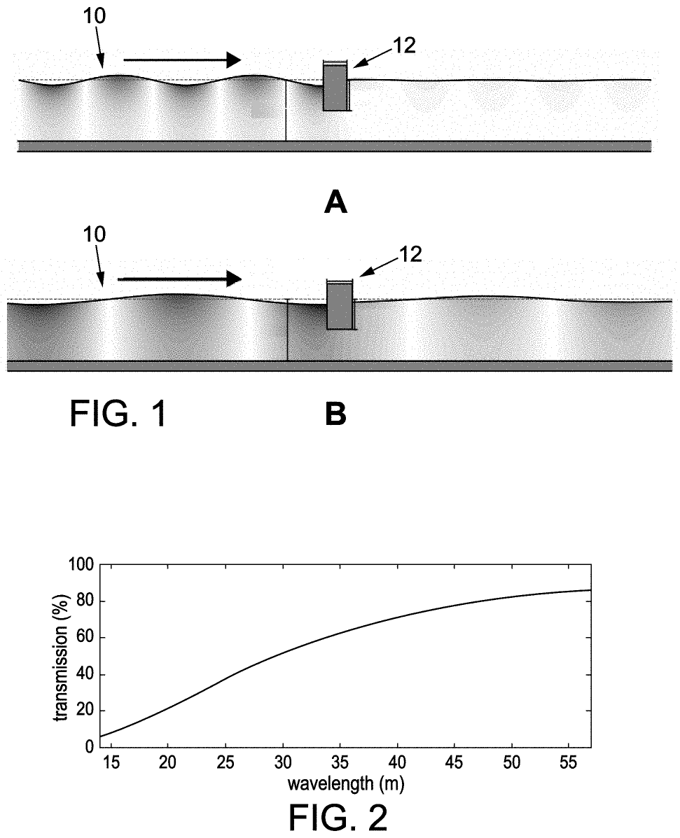

### DETAILED DESCRIPTION

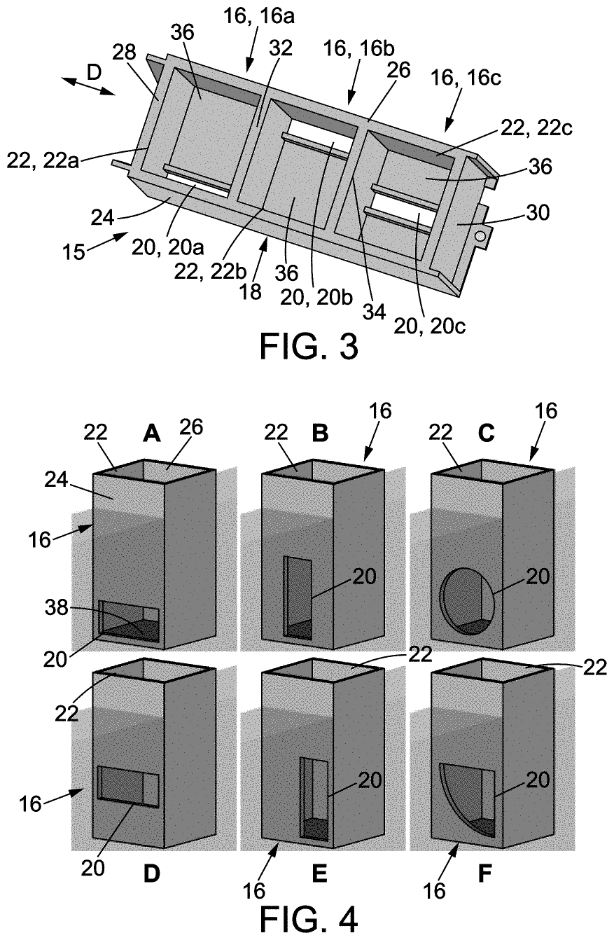

Reference is now made to FIGS. 3 et seq. which illustrate the invention as set forth herein.

According to the present disclosure, instead of using a wall as in the prior art, it is proposed to use a plurality of resonators 16 formed by resonant cavities 16 in which an oscillation of water is generated in phase opposition with the waves incident on the device 15 hereinafter described. These resonators have a width, i.e., a dimension along the direction of propagation of the waves, a length along a direction perpendicular to the direction of propagation of the waves, these two said directions being perpendicular to a vertical direction (corresponding to the direction of the earth's gravity). Each cavity has a width chosen to be about 10 times smaller than the central wavelength of the waves. In practice, the length of the cavities can take variable values without affecting the operation of the device. The width of each cavity is chosen to have a width equal to about 1/10 of the wavelength of the wave whose amplitude is to be attenuated.

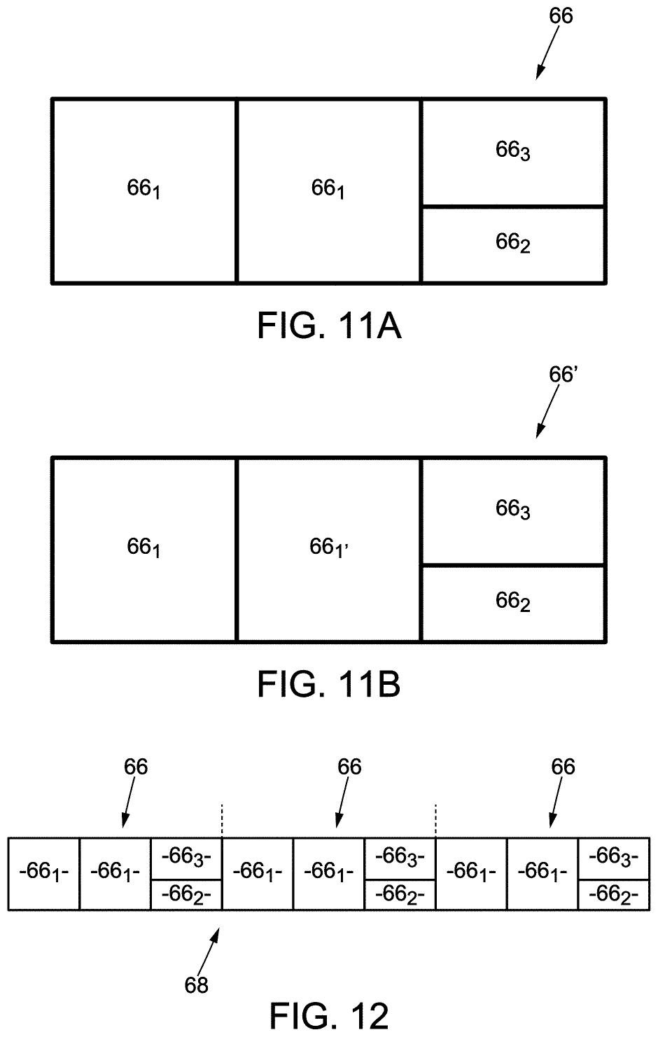

The device according to the present document comprises a plurality of modules 18 juxtaposed next to each other along a given direction D (FIG. 11A and FIG. 11B). The modules 18 so juxtaposed form an assembly that extends along said direction D. The device 18 may include a single set of resonators or multiple sets as shown in FIG. 11 and described later.

Each module 18 includes at least one cavity 16 having a first opening 20 and a second opening 22. In the case shown in FIG. 3, each module 18 includes three cavities 16a, 16b, 16c but could include fewer or more depending on the ability to move a module 18.

As can be seen in FIG. 3, the illustrated module 18 comprises three resonant cavities, a first cavity 16a, a second cavity 16b and a third cavity 16c, each having a first opening 20a, 20b, 20c and a second opening 22a, 22b, 22c. Each module 18 comprises an upstream wall 24 and a downstream wall 26, the upstream wall 24 being intended to be arranged opposite the waves and the downstream wall 26 opposite the port or the coastline to be protected.

The module 18 also comprises two side walls 28, 30 which define side walls of the first cavity 16a and the third cavity 16c. It is understood that when the module 18 comprises only one resonant cavity, then the two sidewalls 28, 30 of the module laterally define the same cavity.

In the case shown in FIG. 3, the module 18 includes two intervening walls 32, 34 which together delimit the second cavity. Each cavity 16 is also bounded by a bottom wall 36.

As can be seen in FIG. 3, each first opening 20 is formed in the bottom wall 38, but the first openings 20a, 20b, 20c are not placed in the same location on the bottom wall 36. Note that the first openings 20a, 20b, 20c could also be aligned. The first openings 20a, 20b, 20c have the shape of a slot, and more generally the shape of a larger rectangle extending in a direction perpendicular to the direction of wave propagation and vertical when the device 15 is in use.

As is clearly visible in FIG. 3, each second aperture 22a, 22b, 22c is bounded by the upper edge of the side walls 28, 32, 34, 30 and the upstream 24 and downstream 26 walls of each resonant cavity 16. More generally, a second opening 22 could have another shape without affecting the operation of the invention. Indeed, the second opening 22 which is open to the ambient air allows air to flow in and out of the cavity to allow for a variation in the water level in the resonant cavity 16 so that it can perform the desired resonant function. The purpose here is to limit the height of the device to the strict height necessary for the operation of the invention to avoid any negative visual impact that the device could cause to walkers or boaters.

As illustrated in FIG. 4, a resonant cavity may have a first aperture with a variable shape, which has little effect on the desired resonance phenomenon. Thus, the shape of the first aperture may be:
Rectangular with the largest dimension extending along the direction D and arranged in the vicinity of the bottom wall (variant A),
Rectangular with the largest dimension being vertical (variant B),
Circular (variant C),
Similar to variant A but with a more central positioning of the first opening on the upstream wall (variant D),
Similar to variant B but with positioning of the first opening near a side wall,
A disk portion having an angular opening which may be, for example, 90°.

The first openings 16 described in FIG. 4 could be formed on the downstream wall 26 or the bottom wall 38 or the upstream wall 24.

The assembly formed by the modules 18 is arranged opposite the waves, for example perpendicular to the direction of propagation of the waves in the case where only one assembly is used. The modules 18 are placed in a position in which the first opening 20 of each cavity 16 is permanently immersed and in which the second opening 22 is in communication with the ambient air, i.e. the second opening 22 is never immersed, the dimensions of the cavities 16 being determined so that each cavity 16 forms a resonant cavity at the central wavelength of the waves. The assumption is made here that the waves have a central wavelength, i.e., that the bulk of the wave energy is at a known and fixed frequency, at least over a given period of time that changes little during a day, which makes the method and device according to the present document particularly interesting.

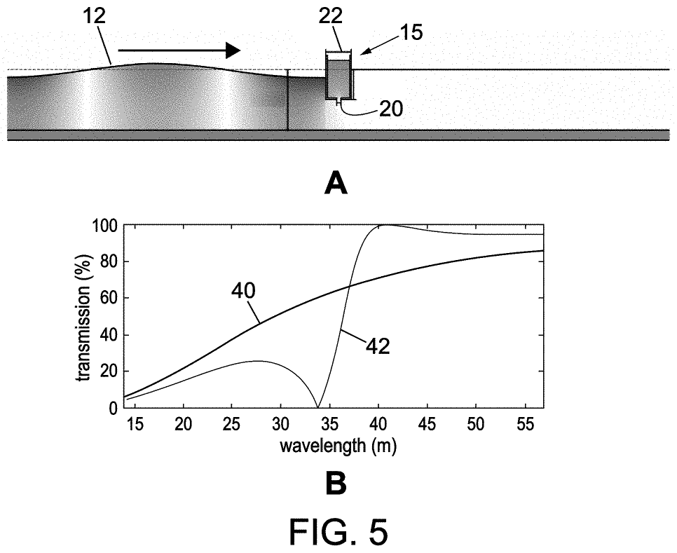

FIG. 5A illustrates the positioning of the device 15 according to the present disclosure in water with the first opening 20 submerged and the second opening in communication with the ambient air.

Unlike the prior technique, the use of resonant cavities 16 allows for reduced wave transmission (transmitted wave amplitude over incident wave amplitude) through the modules 18 over a wider range of wavelengths. The graph of FIG. 5B illustrates the variation of the transmission rate in percentage as a function of the wavelength, the curve 40 corresponding to the curve of FIG. 2 and the curve 42 corresponding to an assembly whose dimensional characteristics are: cavity width=3 m, opening width=0.5 m, the first opening 20 being arranged on the bottom wall 38. On this graph, it can be seen that the transmission is less important than for the previous technique up to a wavelength of 37 m.

In a practical embodiment of the invention, the first opening 20 of each resonant cavity 16 has a cross-sectional area between 0.5 and 5 m². The height of water separating a bottom of each cavity 16 is less than half the height of water separating the bottom.

The cavities have characteristic dimensions that are smaller than the wavelength and suitable for resonance at the center frequency of the waves. In practice, each of the dimensions of the cavity is at least 10 times smaller than the central wavelength of the waves.

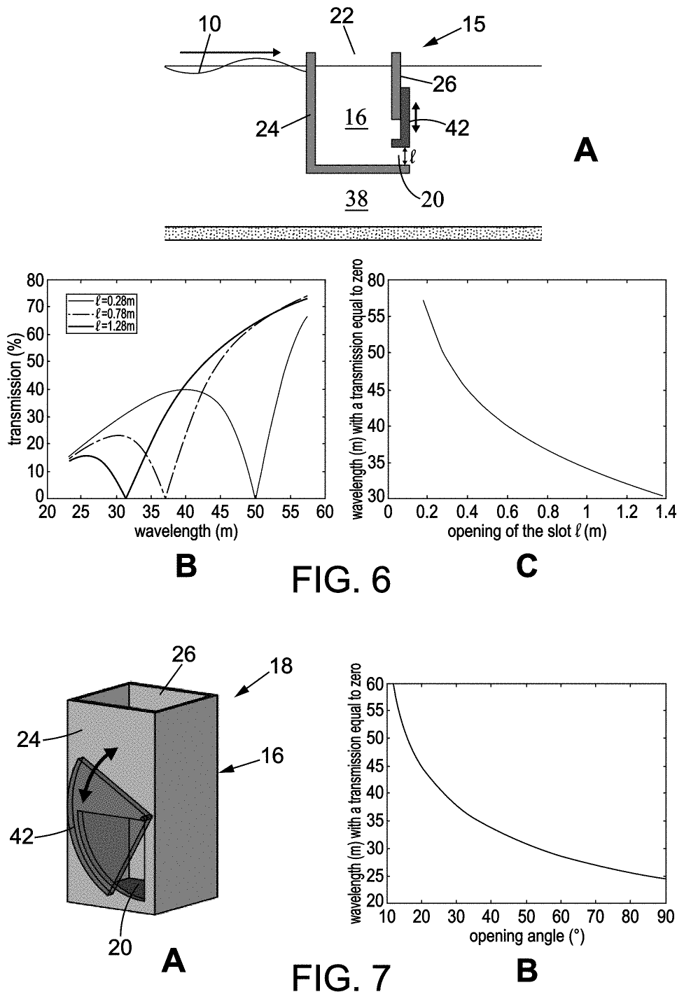

FIG. 6A illustrates another embodiment of the invention in which each resonant cavity 16 includes a movable member 42 for varying the cross-sectional area of the first aperture 20, which movable member 42 may be a vertically slidable door. The movable element 42 thus allows the cross-sectional area of the first opening 20 to be reduced or increased. FIG. 6B depicts three curves of percent transmission rate versus wavelength for three different cross sections. It can be seen that varying the cross-sectional area allows the resonant frequency of the cavity 16 to be shifted, which makes the invention even more interesting when the movable element 42 is coupled to means for controlling means for moving the movable element and the control means receive input information from means for measuring the wave frequency. An active control of the resonance frequency of the resonators or resonant cavity 16 is then possible.

The graph in FIG. 6C shows the variation of the resonant wavelength as a function of the cross-sectional area of the first opening in meters. This graph indicates that the larger the cross-sectional area of the first aperture, the smaller the resonant wavelength, which can also be seen in the graph in FIG. 6B.

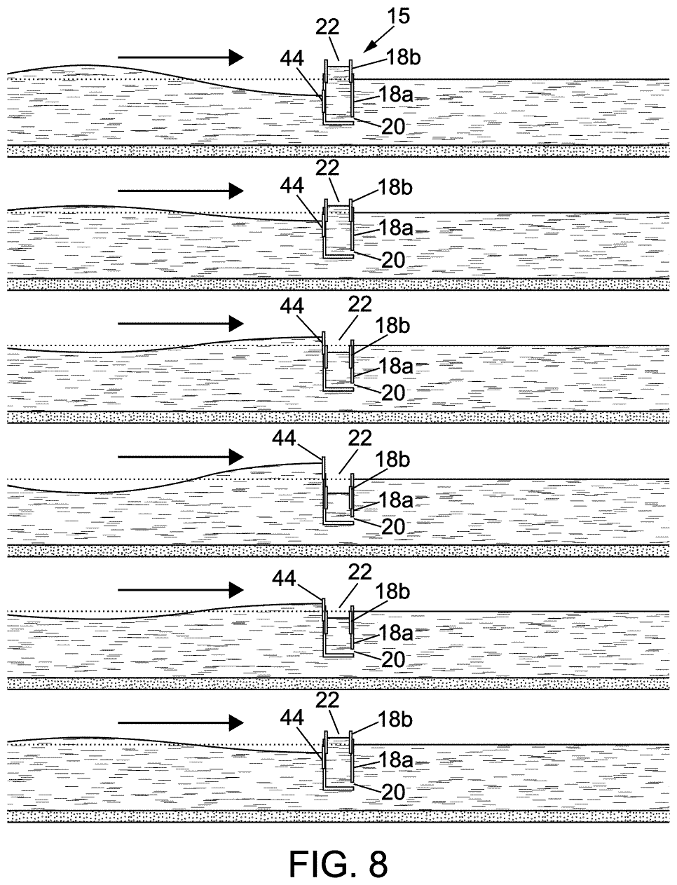

FIG. 7A illustrates an alternative embodiment in which the first aperture 20 has a variable cross-section with a member movable 42 about an axis of rotation, the first aperture 20 having the shape of a disc portion whose cross-section can vary between 0° and 90°.

FIG. 7B illustrates the same type of graph as explained in reference to FIG. 6C.

FIG. 8 illustrates an embodiment that can be coupled with a variable cross-section first opening 20 as previously described but not shown in the figures. In this embodiment, each module 18 includes a first portion 18a having the first opening 20 and a second portion 18b having the second opening 22 and sealingly movable relative to the first portion 18a so as to vary the height position of the second opening 22. This second portion may be configured to slide sealingly relative to the first portion 18a and includes float means. In addition, each module 18 includes a movable panel 44 sealingly on an upstream wall of the module, said panel including float means.

As illustrated in FIG. 8, when an incident wave of significant amplitude is likely to overwhelm the first module portion 18, the movable medium float panel 44 can follow the wave movement up and down in succession to prevent the wave from passing over the first module portion. In the resonant cavity, it is observed that the second part 18b follows the oscillating movement of the water level preventing the water in the resonant cavity 16 from exiting the cavity, thus allowing the cavity 16 to continue to perform its function as a resonant cavity, with the second opening 22 still emerged.

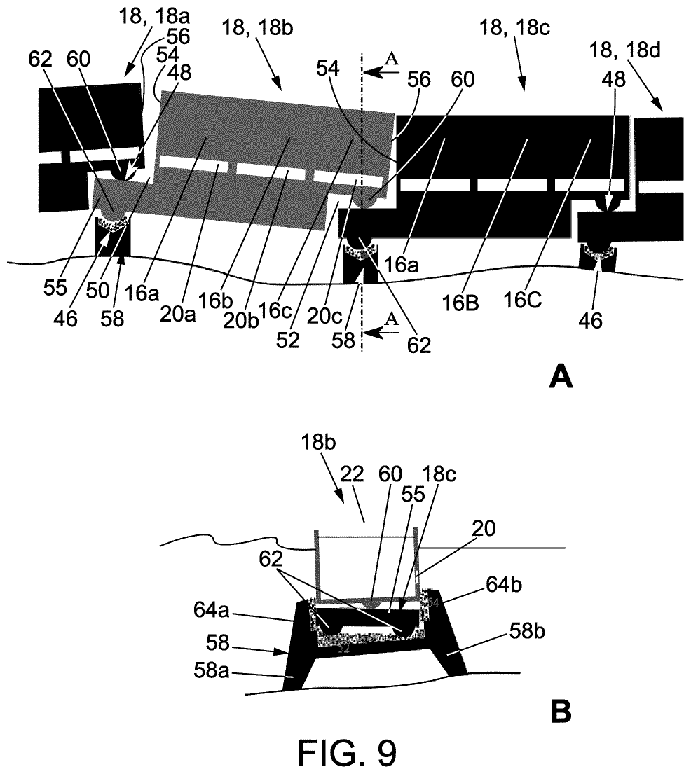

FIG. 9 shows the connection between several modules 18 arranged side by side. The modules 18 may be structurally distinct from each other and connected to each other by an isostatic connection. Each module 18 may be connected at a first lateral end to the bottom of the water by an annular linear connection 46 and at its second lateral end by a point connection 48 to the first end of an adjacent module 18. If these connections are based on levelled embankments, then this type of connection allows for variations in the level of the water bottom on which the modules are intended to be placed when they are placed on the water bottom. The annular linear connection of each module 18 to the water bottom is made on studs attached to the bottom. The point connection 46 can be made by a spherical foot resting on a plane and the linear-annular connection 48 can be made by a V-shaped groove in which spherical feet are mounted.

In the example shown in FIG. 9, and visible in FIG. 9A, each module includes three resonant cavities 16a, 16b, 16c, each resonant cavity including a first opening 20 and a second opening 22 visible in FIG. 9B. Each module 18 includes a first side recess 50, for example L-shaped, formed at a first lateral end of the module 18 and optionally second side recess 52, for example L-shaped, formed at a second lateral end of the module 18.

As can be seen in FIG. 9A, the device includes a plurality of modules 18a, 18b, 18c, 18d arranged side-by-side laterally. For a given module 18b, the first recess 50 is bounded by a first side wall 54 of the module 18b and by a portion projecting 55 laterally toward the adjacent module 18a laterally on a first side. The first side wall 54 of module 18b is arranged laterally opposite a second side face 56 of adjacent module 18a. This laterally projecting portion 55 is arranged vertically between a second end of the adjacent module 18a and a supporting structure 58 or support laid on the bottom.

As can be seen in FIG. 9A, the modules 18 cooperate by interlocking with each other such that:
the first recess 50 of a given module 18b receives the second end of an adjacent module 18a laterally from a first side, the projecting portion 55 of the given module 18b being interposed vertically between said second end of the adjacent module 18a and a supporting structure 58, and the second recess 52 receives the projecting portion 55 of the adjacent module 18c laterally from a second side, said projecting portion 55 being vertically interposed between the second end of the given module 18b and another supporting structure 58.

The second end of each module 18 makes a point connection with the projecting portion of an adjacent module, said projecting portion 55 making an annular linear connection with the supporting structure 58. To make a point connection, each second end of a module 18, 18b includes a spherical foot 60 resting on a substantially flat surface of the projecting portion 55 of the adjacent module 18c on a second lateral side. It is noted that the foot 60 could be formed on the projecting portion 55 and could abut a substantially planar surface of the second end of the module 18b. To achieve an annular linear connection, each projecting portion 55 comprises two spherical feet 62 (FIGS. 9A and 9B) engaged in a V-section groove of a supporting structure 58 or support. Note that the spherical feet 62 could be formed on the supporting structure 58 and the foot receiving groove formed on the projecting part 55.

Each supporting structure 58 comprises at least two upstream legs 58a and downstream legs 58b connected to each other by the V-groove, the legs 58a, 58b extend upwards by upstream and downstream low walls 64a, 64b whose upper edges are respectively positioned so as to be arranged opposite an upstream wall and a downstream wall of the module making the point connection with the module comprising a projecting part 55. The upper edges of the low walls 64a, 64b can also be arranged opposite an upstream wall and a downstream wall of the module comprising a projecting part 55. In this way, the low walls provide simultaneous support for two adjacent modules. Each supporting structure can include three legs so as to achieve an isostatic connection of the leg to the bottom of the water.

Backfill is disposed in each V-groove and between the walls 64a, 64b and a projecting portion 55 of a module 18c and between the walls 64a, 64b and the upstream and downstream walls of the module 18b making the point connection with the module 18c having said projecting portion 55.

The embankment 54 prevents any tilting of the modules 18 related to the buffering effects of the wave energy. This embankment 54 allows to compensate for the horizontal defects of the modules 18 between them. Thus, the supporting structures or supports 50 coupled to the footing systems 60a, 60b and 61, as well as the use of level embankments 52 and anti-tilt embankments 54 allow to compensate the orientation and level defects of the modules 18 between them.

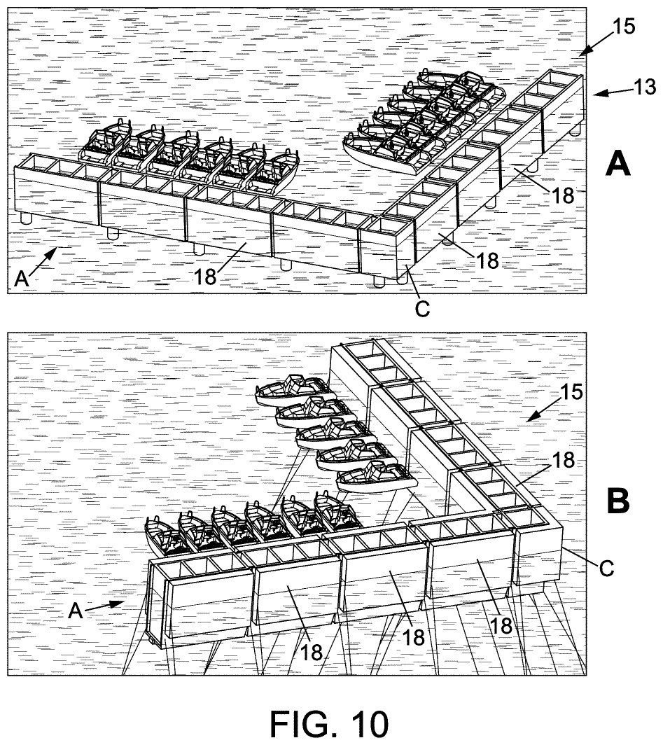

FIG. 10 illustrates a first variant (FIG. 10A) of fixing the studs to the bottom of the water using studs for example as described with reference to FIG. 9 and a second variant (FIG. 11B) in which the modules are connected to each other using chains or cables. The modules comprise floating means and are anchored to the bottom of the water by cables or chains put under tension.

It can be seen that the device 15 comprises two sets A, B of modules, connected to each other in such a way as to present a V shape, the vertex C of which is oriented towards the arrival of the waves. The V-shape may have an angle of between 30 and 120°. The device 15 may comprise several pairs of V-shaped assemblies A, B arranged successively so as to present a VV or VVV shape, for example, the extent of the device 15 depending on the zone of the area to be protected.

FIG. 11A illustrates a module 66 comprising N resonant cavities, each cavity having a first aperture and a second aperture which are not shown in this figure. Of these N cavities, at least k cavities have different widths in pairs, with k being less than or equal to N. The width of each of the k cavities is thus adapted to resonate at a different center frequency than the other k cavities, so that when a wave impacts a module, each of the k cavities will thus resonate at a different frequency.

By using k cavities as defined above, it is thus possible to achieve wave amplitude attenuation over a wide frequency range.

In the example shown, N is equal to 4 and k is equal to 3. Thus two first cavities 66₁ are dimensionally identical and have the same first width and length.

In the example shown, in FIG. 11A, with any dimensional parameter other than width being identical between the cavities 66₁, 66₂, 66₃, the cavities 66₁ resonate identical frequencies.

It would still be possible to have a configuration of a module 66′ as shown in FIG. 11B. In this one, it is observed that the cavities 66₁ and 66_{1′} have an identical width but have different resonant frequencies because the openings are different, in particular the first openings of the cavities 66₁ and 66_{1′} are different and the second openings of the cavities 66₁ and 66_{1′} are identical.

The module includes a second 66₂ and a third 66₃ cavity whose sum of the widths is equal to the first width. The second width of the second cavity 66₃ is less than the third width of the third cavity 66₃.

The first openings of the cavities 66₂ and 66₃ may be identical but may also be different. The second openings of these cavities 66₂, 66₃ may be identical.

The first two cavities 66₁ are arranged side by side. The second cavity 66₂ and the third 66₃ cavity are arranged one behind the other according to the direction of wave propagation. The second 66₂ and the third 66₃ cavities are arranged at a lateral end of the module 66. They could also be arranged between the first two cavities 66₁.

FIG. 12 illustrates an assembly 68 comprising a plurality of modules 66 as shown in FIG. 11A. Alternatively, a module assembly 66′ as shown in FIG. 11B or a combination of modules 66 and 66′ could be made.

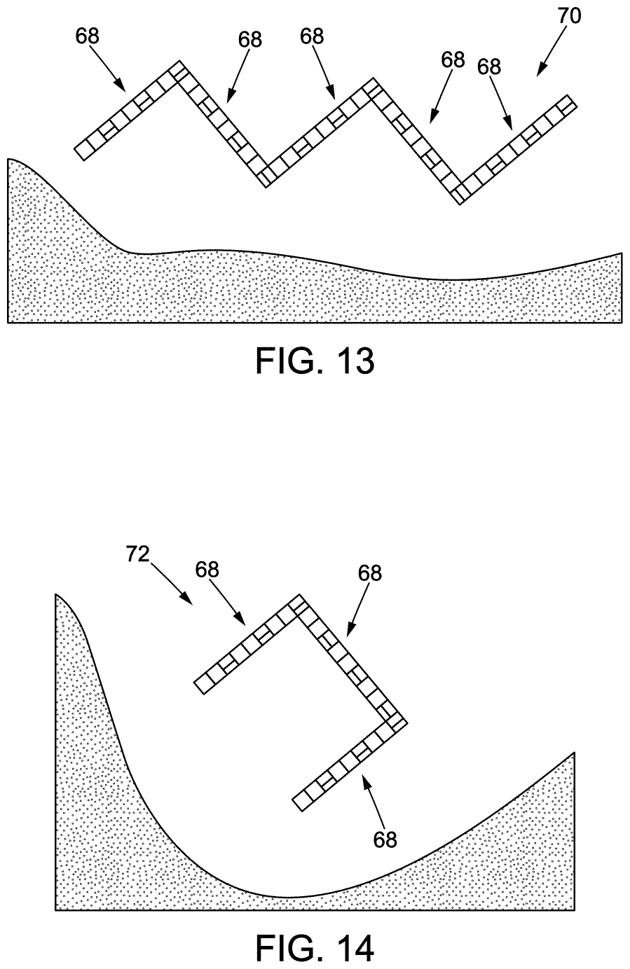

The assembly 70 may include a plurality of modules 68 (or any other module described above) and the modules may have a shape comprising an even or odd succession of modules 68 with a crenellated to V-shaped shape as illustrated in FIG. 13. The assembly may also have a more general zigzag shape that may follow a straight or curved guideline. The modules 68 may be arranged at right angles to each other and successively connected to each other at their ends. Alternatively, the assembly 72 may include three modules 68 as shown in FIG. 14 or any other embodiment of a module described herein, the three modules 68 being generally U-shaped, with the opening of the U allowing boat access to the protected area within the U.

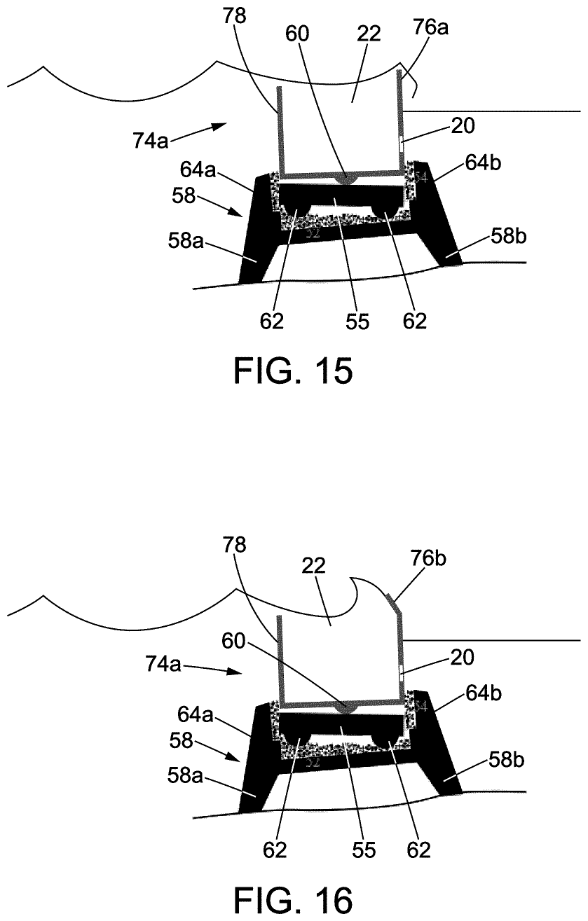

FIG. 15 illustrates a module 74a in which the downstream wall 76a of each module 74a has a height greater than the height of the upstream wall 78 so as to prevent a wave from submerging the device. This compensates for any weakness in wave frequency filtration. For example, when a series of waves having a central frequency that is difficult to attenuate by the device (because the series of waves is rare) arrives on it, the raised downstream wall 78 can block the propagation of the wave as in a conventional device such as a dike.

The downstream wall 76b of the raised module 74b may further include an upper end portion that faces upstream so as to create a counterflow to further limit submergence of the device.

1-19. (canceled)

20. A method of attenuating the amplitude of waves transmitted through a device, the waves having a given center frequency and the method comprising using the device comprising:
an assembly of a plurality of modules juxtaposed next to each other along a given direction, each module comprising at least one cavity having a first opening and a second opening;
wherein the modules are placed in a position in which the first opening of each cavity is permanently submerged and the second opening is in communication with the ambient air, the dimensions of the cavities and openings being determined so that at least one cavity of each module forms a resonant cavity at the given center frequency.

21. The method according to claim 20, wherein each module comprises at least two resonant cavities arranged side by side.

22. The method according to claim 20, wherein the height of water separating a bottom of each cavity is less than half the height of water separating the bottom.

23. The method according to claim 20, wherein the device comprises a movable member for varying the cross-section of the first opening.

24. The method according to claim 23, wherein the device comprises means for measuring the central wavelength of the waves, which means are connected to means for controlling means for moving the movable element.

25. The method according to claim 20, wherein each module comprises means adapted to vary the height position of the second opening of each cavity.

26. The method according to claim 25, wherein each module comprises a first portion having the first opening and a second portion having the second opening and sealingly movable relative to the first portion so as to vary the height position of the second opening.

27. The method according to claim 26, wherein the second portion is configured to slide sealingly relative to the first portion and includes float means.

28. The method according to claim 26, wherein each module comprises a movable panel sealed to an upstream wall of the module, said panel having float means.

29. The method according to claim 20, wherein the modules are structurally distinct from each other and connected to each other by an isostatic connection.

30. The method according to claim 20, wherein the device comprises at least two assemblies of the aforementioned type, connected to each other so as to have a V shape.

31. The method according to claim 20, wherein the device comprises a plurality of assemblies of the aforementioned type so as to present a V-shaped succession.

32. The method according to claim 31, wherein the V-shape has an angular opening between 30° and 120°.

33. The method according to claim 20, wherein the modules are placed on the bottom of the water or have positive buoyancy and are retained on the bottom of the water.

34. The method according to claim 20, wherein each module comprises N resonant cavities with at least k cavities having different widths in pairs, k being less than or equal to N, the width being measured along the wave propagation direction.

35. The method according to claim 20, each cavity has a width measured along the direction of wave propagation, which is about 10 times smaller than the center wavelength of a wave to be attenuated.

36. The method according to claim 20, wherein each cavity has the shape of a cylinder, for example the shape of a straight cylinder.

37. The method according to claim 36, wherein the cylinder is open at one end along a generatrix to form the second opening.

38. The method according to claim 20, wherein each module has a width that is constant.
